(19) United States
(12) Patent Application Publication
(10) Pub. No.: US 2006/0256407 A1
(43) Pub. Date: Nov. 16, 2006

(54) Color conversion based on multiple color conversion profiles

(76) Inventor: Jun Hoshii, Nagano-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/412,277

(22) Filed: Apr. 26, 2006

(30) Foreign Application Priority Data
May 11, 2005 (JP) 2005-138204
May 11, 2005 (JP) 2005-138205

(51) Int. Cl. G06K 9/00

(52) U.S. Cl. 358/518; 358/1.9; 382/167

(57) ABSTRACT

A color conversion method according to the invention acquires a first color conversion profile and a second color conversion profile, wherein a plurality of output values in the first color conversion profile matches a plurality of input values in the second color conversion profile. The method acquire a weight profile indicative of weights for interpolating an output value corresponding to a given input value by using a weighting operation based on a plurality of output values in the first color conversion profile. The method acquires a plurality of reference input values referenced to interpolate an output value corresponding to a color component value of the image data based on the first color conversion profile. The method acquires a weight for each of the reference input values based on the weight profile. The method acquires an output value corresponding to each of the reference input values based on the second color conversion profile. The method multiplies each of the output values by the acquired weight to generate image data after color conversion.

The entire disclosure of Japanese Patent Application No. 2005-138205, filed May 11, 2005, is expressly incorporated by reference herein.

The entire disclosure of Japanese Patent Application No. 2005-138204, filed May 11, 2005, is expressly incorporated by reference herein.

### BACKGROUND OF THE INVENTION

1. Field of the Invention

The present invention relates to a technology that accelerates a color conversion process based on multiple color conversion profiles.

2. Description of Related Art

Image devices such as displays and printers generally use image data that represents each pixel color using a color component value (gradation value for each color component). Basically, the color based on the color component value is device-dependent. When different image devices treat the same image, the color conversion is performed for color matching. The color conversion is performed based on a color conversion profile. The color conversion profile is previously created to define the correspondence between colors in different color coordinate systems. The interpolation references the color conversion profile to convert any colors. Various factors such as color gamut differences and stored colors need to be considered to define the correspondence for a given color coordinate system. Accordingly, multiple color conversion profiles may be used for the color conversion. It is time consuming to individually repeat the color conversion each time the color conversion is performed based on multiple color conversion profiles. As a countermeasure, there is the known technology to previously merge multiple color conversion profiles (e.g., U.S. Pat. No. 5,432,906).

It has been difficult for the above-mentioned technology to fast perform the color conversion based on any multiple color conversion profiles. When the construction requires a process that merges multiple color conversion profiles, it is necessary to previously create a merged color conversion profile. No color conversion can be performed based on a profile merged based on any color conversion profile. Even based on a merged color conversion profile, fast color conversion is difficult when an interpolation is individually performed for each pixel during color conversion of many pixels.

### SUMMARY

An advantage of some aspects of the invention is to fast perform color conversion based on any multiple color conversion profiles.

According to a first aspect of the invention, there is provided a color conversion method for applying color conversion to image data whose pixel color is specified by a color component value, the method comprising:

acquiring a first color conversion profile and a second color conversion profile, wherein the first and second color conversion profiles define correspondence between input and output values using multiple combinations and a plurality of output values in the first color conversion profile matches a plurality of input values in the second color conversion profile;

acquiring a weight profile indicative of weights for interpolating an output value corresponding to a given input value by using a weighting operation based on a plurality of output values in the first color conversion profile;

acquiring a plurality of reference input values referenced to interpolate an output value corresponding to a color component value of the image data based on the first color conversion profile;

acquiring a weight for each of the reference input values based on the weight profile;

acquiring an output value corresponding to each of the reference input values based on the second color conversion profile; and

generating image data after color conversion by multiplying each of the output values by the acquired weight.

According to a second aspect of the invention, there is provided a color conversion device for applying color conversion to image data whose pixel color is specified by a color component value, the device comprising:

a matching profile acquisition unit that acquires a first color conversion profile and a second color conversion profile, wherein the first and second color conversion profiles define correspondence between input and output values using multiple combinations and a plurality of output values in the first color conversion profile matches a plurality of input values in the second color conversion profile;

a weight profile acquisition unit that acquire a weight profile indicative of weights for interpolating an output value corresponding to a given input value by using a weighting operation based on a plurality of output values in the first color conversion profile; and a color conversion unit that acquires a plurality of reference input values referenced to interpolate an output value corresponding to a color component value of the image data based on the first color conversion profile, acquires a weight for each of the reference input values based on the weight profile, acquires an output value corresponding to each of the reference input values based on the second color conversion profile, and performs color conversion by multiplying each of the output values by the acquired weight.

The weight is a value that is multiplied by an output value defined in the first color conversion profile to perform interpolation. Output values in the first color conversion profile match input values in the second color conversion profile. Multiplying the weight by output values in the second color conversion profile converts image data colors.

The second color conversion profile maintains a correspondence between multiple combinations of input values and multiple combinations of output values. When multiple output values in the first color conversion profile match multiple input values in the second color conversion profile, only reference to the second color conversion profile can acquire output values in the second color conversion profile corresponding to multiple output values in the first color conversion profile. When the weight to be multiplied by output values in the first color conversion profile is multiplied by output values in the second color conversion profile during the interpolation based on the first color conversion profile, this is equivalent to performing the color conversion based on both the first and second color conversion profiles.

As a result, the conversion based on the second color conversion profile can be performed without performing the interpolation for each pixel. The process of multiplying the weight by output values in the second color conversion profile is equivalent to the interpolation. The weight profile can be used to acquire the weight to be multiplied. The fast process is available in comparison with the process of calculating a weight for a given color component value. The process equivalent to the interpolation based on one profile can provide the conversion based on two profiles, i.e., the first and second color conversion profiles. It is possible to perform the conversion based on two profiles.

The invention only needs a match between multiple output values in the first color conversion profile and multiple input values in the second color conversion profile. Both only need to already match when the color conversion is performed. The color conversion may acquire a profile containing a match between both or may reference a profile containing no match between both and perform a process for matching both. As a result, the invention is available through the use of any color conversion profiles. It is possible to perform color conversion based on any multiple color conversion profiles.

The respective profiles only need to define the correspondence between input and output values using multiple combinations to specify the correspondence between two different color coordinate systems. That is, the color coordinate system represents colors by combining color component values for multiple color components. When there is the correspondence between a combination of color component values in the first color coordinate system and a combination of color component values in the second color coordinate system, the color coordinate system can be converted with respect to a given color.

When the above-mentioned combinations are further defined for multiple colors, the interpolation can convert the combination of any color component values in the first color coordinate system into the combination of any color component values in the second color coordinate system. In consideration for this, the specification uses the combination of color component values before the color conversion as input values and the combination of color component values after the color conversion as output values. The invention makes a correspondence between output values in the first color conversion profile and input values in the second color conversion profile. Only reference to the weight profile can perform conversion based on the first and second color conversion profiles without calculating a weight for each pixel and performing the interpolation for each profile.

Accordingly, it is only necessary to ensure a match between output values and input values in the second color conversion profile corresponding to color component values to be converted. To improve the general versatility, however, it is desirable that all output values in the first color conversion profile match all input values in the second color conversion profile.

The weight profile acquisition unit only needs to acquire a weight for performing the interpolation based on the first color conversion profile. There is no limitation on interpolation techniques as long as a weighting operation is used for the interpolation. For example, it is possible to employ the interpolation that defines weights based on the correlation between the reference input value to be referenced during the interpolation and a given color component value, e.g., a volume ratio of solids formed by reference input values and color component values in a color specification space. In addition, various interpolations can be employed such as the interpolation that defines weights according to a distance between the reference input value and the color component value.

The weight profile acquisition unit can only prevent individual weight calculation by acquiring such profile that defines weights. Therefore, it may be preferable to use a precreated weight profile or calculate weights before the color conversion and create a profile for the calculated weights. While the latter necessitates the weight calculation, it is unnecessary to individually calculate a weight for each pixel once the weight profile is created. The weight calculation does not heavily burden for the entire color conversion for image data, making it possible to accelerate the color conversion. In addition, the weights can be shared when the correlation between multiple input values defined in the color conversion profile is common to the other input values. In this case, it is unnecessary to calculate weights for all input values defined in the first color conversion profile. Again, the processing speed can be improved for the entire color conversion.

An image data acquisition unit acquires image data whose pixel color is specified by a color component value. The image data acquisition unit only needs to acquire image data indicative of an image whose colors are to be converted. Various constructions can be employed for the image data acquisition unit. An available construction may acquire image data for an image to be printed targeted for the color conversion during printing. Another available construction may acquire image data for a scanned image targeted for the color conversion during scanning. The image data only needs to have pixel colors capable of being specified by color component values. It is possible to employ various color coordinate systems that specify pixel colors.

The color conversion unit only needs to be able to acquire a weight based on the weight profile and acquire an output value in the first color conversion profile corresponding to a given color component value and a corresponding output value in the second color conversion profile. Similarly to ordinary interpolation, an output value in the first color conversion profile corresponding to a given color component value can be easily acquired by comparing the color component value with the input value in the first color conversion profile. For example, the color conversion unit acquires multiple input value sandwiching or surrounding the color component value out of input values in the first color conversion profile. The color conversion unit then references the first color conversion profile and acquires output values corresponding to the input values.

The output value is defined in the first color conversion profile. The value corresponds to any of input values defined in the second color conversion profile. Accordingly, referencing the second color conversion profile can make a correspondence to output values in the second color conversion profile. As a result, it is possible to acquire an output value in the second color conversion profile to be multiplied by the weight.

There may be a preferable construction that enables the color conversion based on undefined multiple color conversion profiles. According to the construction, the interpolation is used to create at least one of the first and second color conversion profiles from an undefined original color conversion profile. When an undefined original color conversion profile is assumed, a combination of input values or output values is also undefined. When the interpolation is performed by referencing the original color conversion profile, it is possible to use a given color component value as an input value and acquire an output value corresponding to the input value.

When the interpolation is performed by referencing a precreated original color conversion profile, it is possible to easily make a correspondence between multiple output values in the first color conversion profile and multiple input values in the second color conversion profile. Whatever color conversion profile may be used, the above-mentioned construction enables fast color conversion based on both the first and second color conversion profiles.

The requirement here is to be able to make a correspondence between multiple output values in the first color conversion profile and multiple input values in the second color conversion profile. It is only necessary to perform the interpolation for either the first or second color conversion profile. Of course, the interpolation can be performed for both. The invention allows input values in the second color conversion profile to correspond to output values in the first color conversion profile. It is possible to easily make a correspondence between input and output values when the interpolation is performed by using output values in the first color conversion profile as input values and referencing the second color conversion profile.

The above-mentioned construction needs to perform the interpolation based on the precreated original color conversion profile. However, the interpolation only needs to be performed once before the color conversion of image data. The number of values to be defined as input values for a color conversion profile is much smaller (e.g., 33³ or 65³) than the number of pixels (several megapixels) of image data contained in photos. Accordingly, fast processing is possible even when the interpolation creates the first or second color conversion profile.

The weight profile only needs to be capable of defining weights as a profile for performing the interpolation using the first color conversion profile. According to a preferable construction, a weight may be defined for a given unit region. That is, let us define a given unit region to be formed in the color specification space by multiple input values in the first color conversion profile and specify a interpolation rule. Under this condition, it is possible to calculate a weight to be multiplied by output values corresponding to multiple input values for interpolating color component values in the unit region. In this case, the weight can be defined for a color component value within the specified unit region.

Let us suppose that the correlation between multiple input values forming the specific unit region in the color specification space is the same as the correlation between multiple input values in the other regions. In this case, weights defined for that unit region can be shared. For example, let us assume a case of forming equally sized cubic lattices in the color specification space by combining multiple input values in the first color conversion profile. When a weight is defined for interpolating each of color component values contained in one cube, the same weight can be applied to all the cubes.

Of course, all cubes do not necessarily have the same size. When differently sized cubes fill the color specification space, a weight profile may be created for each of sizes. Further, it may be preferable to use one weight profile to calculate weights for cubes having the other sizes.

The specific unit region is not limited to a cube. A tetrahedron or the other solids may be applicable. The unit region may be not only a cube, but also a planar surface or a straight line. In this case, any color component values can be interpolated by performing the interpolation based on weights at any points on the planar surface or the straight line. When the weight corresponds to the output value in the first color conversion profile, weighting an output value in the second color conversion profile can perform the color conversion based on two profiles.

The weight profile acquisition unit can create such weight profile by calculating a weight for each color component value in the specific unit region. That is, determining the type of interpolation can determine what weight should be used for the output value corresponding to the input value in accordance with the relation between color component values and multiple surrounding input values. Consequently, calculating this weight makes it possible to create the weight profile based on any first color conversion profile, greatly extending the applicable scope of the invention.

For example, let us suppose that the type of interpolation is cubic interpolation. A cube is assumed to be formed by input values in the first color conversion profile. Points are assumed to be formed by given color component values inside the cube so as to calculate the volume of the cube whose vertexes are composed of any one of the lattice points and the given color component values. A ratio of volumes for the respective cubes is assumed to be the weight for a lattice point located opposite the cube. Repeating the weight calculation for the color component values can create the weight profile.

According to a third aspect of the invention, there is provided a color conversion method for applying color conversion to image data whose pixel color is specified by a color component value, the method comprising:

acquiring a first color conversion profile and a second color conversion profile, wherein the first and second color conversion profiles define correspondence between input and output values using multiple combinations and a plurality of output values in the first color conversion profile matches a plurality of input values in the second color conversion profile;

converting a color component value of the image data into an output value in the first color conversion profile based on the first color conversion profile; and

generating image data after color conversion by using an output value in the acquired first color conversion profile as an input value in the second color conversion profile and converting the input value into an output value based on the second color conversion profile.

According to a fourth aspect of the invention, there is provided a color conversion device for applying color conversion to image data whose pixel color is specified by a color component value, the device comprising:

a matching profile acquisition unit that acquires a first color conversion profile and a second color conversion profile, wherein the first and second color conversion profiles define correspondence between input and output values using multiple combinations and a plurality of output values in the first color conversion profile matches a plurality of input values in the second color conversion profile;

a first color conversion unit that converts a color component value of the image data into an output value in the first color conversion profile based on the first color conversion profile; and

a second color conversion unit that generates image data after color conversion by using an output value in the acquired first color conversion profile as an input value in the second color conversion profile and converts the input value into an output value based on the second color conversion profile.

An output value in the first color conversion profile matches an input value in the second color conversion profile. A color component value of the image data can be converted into the output value in the first color conversion profile based on this profile. Subsequently, the conversion can be completed only based on input values and output values defined in the second color conversion profile. Accordingly, no interpolation is needed for the color conversion. The fast color conversion is available based on the first and second color conversion profiles.

The invention only needs to be capable of performing the conversion based on the second color conversion profile without interpolation because of a match between output values acquired by the first color conversion unit and input values acquired by the second color conversion unit.

The first color conversion unit converts a color component value for the image data into an output value in the first color conversion profile based on the first color conversion profile. Accordingly, a given color component value is assigned only to the output value defined in the first color conversion profile. The first color conversion profile defines the relation between input and output values with respect to multiple colors. Performing the interpolation can acquire an output value corresponding to a given color component value.

However, the invention converts any color component value into any of output values defined in the first color conversion profile so as to prevent the interpolation in the second color conversion unit. This conversion is not the interpolation, but is available based on predetermined rules. There is no need for a process that requires many resources. The fast conversion is available.

The second color conversion unit only needs to be capable of converting input values into output values based on the second color conversion profile. Since all the input values match the input values predefined in the second color conversion profile, the fast process is available without interpolation.

Further, the first color conversion unit only needs to be capable of converting color component values for image data into output values in the first color conversion profile. A preferable construction may use a specified gradation conversion rule. That is, the number of output values in the first color conversion profile is smaller than the number of color component values (gradations). The use of a specified gradation conversion rule for decreasing the number of gradations can convert a given color component value into any of the input values in the first color conversion profile and acquire the output value associated with the input value. As a result, any color component value can be converted into any of the output values defined in the first color conversion profile.

Various gradation conversion rules can be used. For example, various techniques can be employed such as the error diffusion for multiple values, the minimized average error method, and the ordered dither method for multiple values. Each color component value may be converted into a specific input value in accordance with random numbers. In this case, it may be preferable to find the sum of a constant previously associated with each color component value and a random number and compare the sum with a predetermined threshold value to determine an input value. In this manner, various rules can be employed. The first color conversion profile maintains one-to-one correspondence between multiple input and output values. Therefore, converting any of color component values into any of input values in the first color conversion profile is equivalent to converting any of color component values into any of output values in the first color conversion profile.

The above-mentioned operations and working effects are also applicable a print control method of providing control of allowing a printing device to print images corresponding to image data generated by the above-mentioned color conversion method. The above-mentioned operations and working effects are also applicable to a print control device that provides control of allowing a printing device to print images corresponding to image data generated by the above-mentioned color conversion device.

The above-mentioned various devices include various modes such that the devices may be built into a unit and may be embodied together with the other methods. For example, the invention is applicable to a print system including the print control device and the printing device. Further, a control program may be executed on the above-mentioned various devices. Accordingly, the invention is also applicable to programs such as a color conversion program and a print control program, computer-readable recording media recording the programs, and program products. The similar operations and working effects are also available.

### BRIEF DESCRIPTION OF THE DRAWINGS

FIG. 1 is a block diagram outlining the construction of a print control device;

FIG. 2 is a flowchart showing a print control process;

FIG. 3 diagramatically shows a profile;

FIG. 4 diagramatically shows a profile;

FIG. 5 shows color conversion operations;

FIG. 6 schematically shows the construction of a color conversion device;

FIG. 7 shows an example of using a one-dimensional weight profile;

FIG. 8 is a block diagram outlining the construction of a print control device;

FIG. 9 is a flowchart showing a print control process;

FIG. 10 diagramatically shows a profile;

FIG. 11 shows color conversion operations; and

FIG. 12 schematically shows the construction of a color conversion device.

### DETAILED DESCRIPTION OF THE PREFERRED EMBODIMENTS

Embodiments of the invention will be described in the following sequence.

(1) Construction of the print control device according to a first embodiment

(2) Print control process

(3) Color conversion operations

(4) Modification of the first embodiment

(5) Construction of the print control device according to a second embodiment

(6) Print control process

(7) Color conversion operations

(8) Modification of the second embodiment

(1) Construction of the Print Control Device According to a First Embodiment

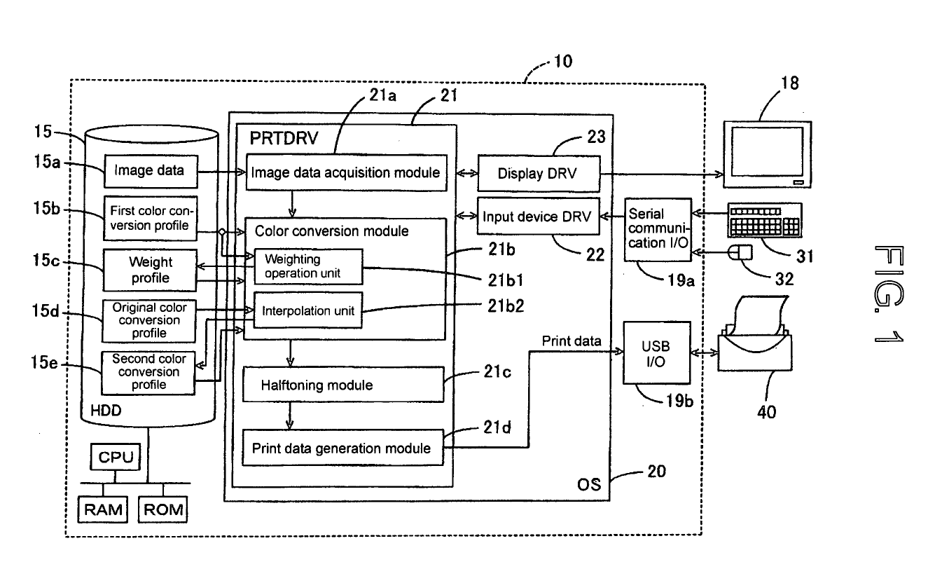

FIG. 1 is a block diagram outlining the construction of a computer that functions as a print control device and a color conversion device according to the first embodiment. A computer 10 includes a CPU as a core of computation, and ROM, RAM, and the like as storage media. The computer 10 can execute specified programs using peripheral devices such as a hard disk drive (HDD) 15. The computer 10 connects with input operation devices such as a keyboard 31 and a mouse 32 via a serial communication I/O interface 19a. The computer 10 also connects with a display 18 via a video board (not shown). Further, the computer 10 connects with a printer 40 via a connection interface 19b such as a USB I/O interface.

The printer 40 according to the embodiment has a mechanism capable of attaching and detaching each of ink cartridges that supply multiple colors of ink. The mechanism is mounted with ink cartridges corresponding to colors CMYKlclm (cyan, magenta, yellow, black, light cyan, light magenta). The printer 40 can generate many colors by combining these ink colors to form color images on printout media. While the printer 40 according to the embodiment is a jet printer, the invention can be applied to various printers not only ink jet printers, but also laser printers and the like.

The invention is not limited to six colors CMYKlclm of ink and may be applicable to four colors CMYK or seven colors CMYKlclmDY (Dark Yellow). Of course, the other colors such as R (red) and V (violet) may be used instead of the lclm inks. Shading inks may be used instead of the K ink. Available connection interfaces between the computer 10 and the printer 40 include a parallel interface, a SCSI interface, and a wireless interface as well as any connection interfaces to be developed in the future.

While the embodiment uses the computer 10 to construct the print control device, various constructions can be employed. For example, a program may be installed in the printer 40 so as to be capable of performing the print control process according to the invention. The print control process may be performed by acquiring image data from a digital camera that is directly connected to the printer 40. According to a similar construction, the digital camera may implement the print control process. In addition, distributed processing may be used to implement the print control process according to the invention. It may be preferable to perform the print control process according to the invention on a so-called complex machine that combines a scanner to scan images with a printer to print images.

The computer 10 according to the embodiment operates on an OS 20 that contains a printer driver (PRTDRV) 21, an input device driver (DRV) 22, and a display driver (DRV) 23. The display driver 23 control display of images to be printed or a printer property screen on the display 18. The input device driver 22 receives code signals from the keyboard 31 or the mouse 32 via the serial communication I/O interface 19a to accept specified input operations.

(2) Print Control Process

The PRTDRV 21 can provide specified processes to print an image that is instructed to be printed from an application program (not shown). To perform printing, the PRTDRV 21 contains an image data acquisition module 21a, a color conversion module 21b, a halftoning module 21c, and a print data generation module 21d. Issuing the print instruction drives the PRTDRV 21. The respective modules provide processes for image data 15a to generate print data. The generated print data is output to the printer 40 via a USB I/F 14. The printer performs printing based on the print data.

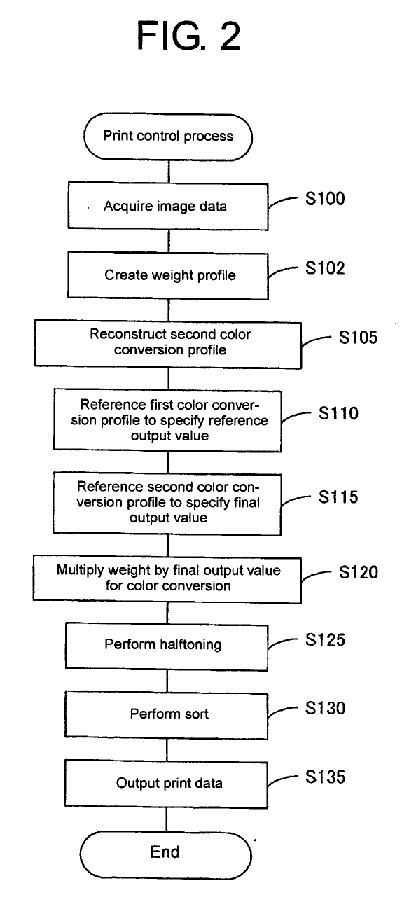

FIG. 2 is a flowchart showing the print control process. When the print instruction is provided, the image data acquisition module 21a first acquires the image data 15a indicating the image that is specified by the application program for printing (Step S100). When the number of pixels is too large or too small for the image data 15a, the image data acquisition module 21a appropriately converts resolutions to ensure pixels needed for printing. According to the embodiment, the image data 15a represents color components of RGB (red, green, blue) in gradations to define a color of each pixel. Each color has 256 gradations.

Data compliant with the sRGB standard is used for RGB color component values of the image data 15a according to the embodiment. Further, various data can be employed such as JPEG image data based on the YCbCr color coordinate system and image data based on the CMYK color coordinate system. Of course, the invention can be also applied to data compliant with the Exif 2.2 standard (Exif is a registered trademark of The Japan Electronics and Information Technology Industries Association) and Print Image Matching (PIM, a registered trademark of Seiko Epson Corporation). In the embodiment, the process at Step S100 is equivalent to the process in an image data acquisition unit U4.

The color conversion module 21b converts the color coordinate system representing pixel colors (Steps S102 through S120). That is, the color conversion module 21b performs the color conversion using a first color conversion profile 15b and an original color conversion profile 15d that are prepared in advance. At this time, the color conversion module 21b creates a weight profile 15c from the first color conversion profile 15b. The color conversion module 21b creates a second color conversion profile 15e from the original color conversion profile 15d. The color conversion module 21b performs the color conversion using the second color conversion profile 15e, the weight profile 15c, and the first color conversion profile 15b.

(2-1) Details of the Profiles

According to the embodiment, the first color conversion profile 15b uses sRGB color component values as input values and RGB color component values as output values for specifying output colors on the printer 40. That is, the first color conversion profile defines first correspondence between input and output values using multiple combinations. Let us assume a given color component value to be an input value of the first color conversion profile. When an weighting operation is applied to output values corresponding to input values approximate to that input value, it is possible to acquire output values corresponding to the given color component value. The weight profile 15c defines the weights. According to the embodiment, the weight profile 15c defines the weights for a minimal cube formed in the sRGB color space according to input values defined in the first color conversion profile 15b.

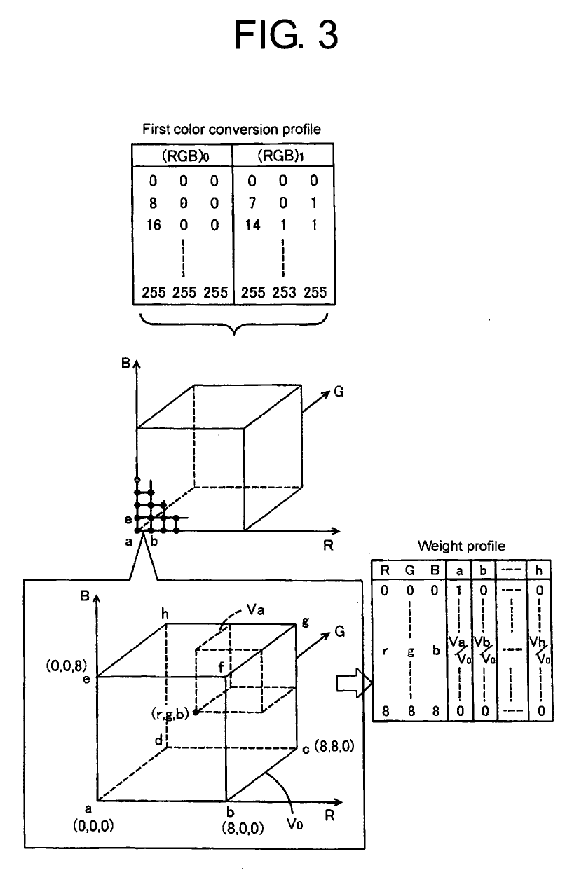

FIG. 3 diagramatically shows the first color conversion profile 15b and the weight profile 15c. In FIG. 3, an example of the first color conversion profile 15b is shown on the top and lists combinations of input values at the left column and output values at the right column. When an input sRGB color component value is (R, G, B)=(8, 0, 0), for example, the corresponding output value is (R, G, B)=(7, 0, 1). In FIG. 3, (RGB)₀ denotes color component values in the sRGB color coordinate system; and (RGB)₁ denotes color component values in RGB color coordinate system for specifying output colors on the printer 40.

The input values provide combinations of values (33 values for each color) resulting from dividing a gradation range of sRGB color component values into 32 for each color. As shown in the middle of FIG. 3, let us consider an orthogonal space using the sRGB colors as axes. Input values are selected so that lattice points corresponding to the input values form a cubic lattice. Of course, the numeric values in FIG. 3 are provided as an example. The invention is not limited to these values or selection of the lattices.

The input values of the first color conversion profile 15b shown at the top of FIG. 3 are disposed at equal intervals in the sRGB color space shown at the middle of FIG. 3 to form equally sized cubic lattices. The weight profile 15c according to the embodiment defines weights in terms of color component values contained in a minimal cube formed by the input values. The same definition is applied to all cubic lattices.

The bottom of FIG. 3 shows details of the weight profile 15c. The bottom left of FIG. 3 shows an enlarged view of the minimal cube formed in the sRGB color space. The input value of the first color conversion profile 15b contains a multiple of 8 corresponding to any of the RGB values. Accordingly, vertexes (a through h) of a cube containing (R, G, B)=(0,0,0) are (R, G, B)=(0,0,0), (8, 0, 0), (8,8,0), (0,8,0), (0,0,8), (8,0,8), (8,8,8), and (0,8,8).

According to the embodiment, the volume interpolation is used to calculate an output value corresponding to a given sRGB value (represented as (R, G, B)=(r, g, b)). For example, a weight corresponding to vertex a of the minimal cube at the bottom of FIG. 3 is calculated based on volume Vₐ of a rectangular parallelepiped whose vertexes are a given sRGB value (r, g, b) and point g opposite the vertex a with respect to the given sRGB value (r, g, b). The weight corresponding to the vertex a is defined in terms of a ratio of the volume Vₐ to volume V₀ of a cube formed by the vertexes a through h.

As shown at the bottom right of FIG. 3, the weight profile 15c defines weights based on the volume ratio with respect to each of sRGB values contained in the cube formed by the vertexes a through h. Accordingly, reference to this weight profile enables an interpolation operation using the following equation (1).

$${( RGB )}_{1 n} = {\sum }_{m = a}^{h} {( RGB )}_{1 m} \cdot \frac{{V}_{m}}{{V}_{0}} \qquad [ Equation 1 ]$$

In this equation, (RGB)ₗₙ is an output value corresponding to a given sRGB value (r, g, b). (RGB)ₗₘ is an output value that is defined in the first color conversion profile 15b and corresponds to any of the vertexes a through h. That is, reference symbol m is assigned reference symbols a through h indicative of the vertexes and indicates the output value corresponding to each vertex indicated by the reference symbol. Vₘ/V₀ denotes a weight defined in the weight profile. Similarly, reference symbol m is assigned reference symbols a through h indicative of the vertexes and indicates the weight corresponding to each vertex. The interpolation is performed for each color component. That is, the weight profile indicates a weight for interpolating the output value corresponding to a given input value using the weighting operation based on multiple output values in the first color conversion profile.

According to the embodiment, the input values of the first color conversion profile are used to form equally sized cubes. Therefore, the weight profile 15c can be used for interpolations at any positions by adding the value for a lattice point corresponding to the vertex a in the cube at a given position to the RGB value in the weight profile.

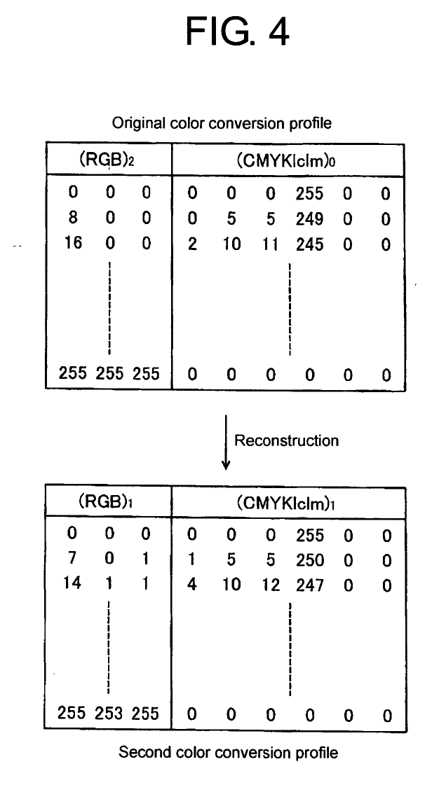

The original color conversion profile 15d uses RGB color component values for specifying output colors on the printer 40 as input values and CMYKlclm values for specifying the amount of ink used for the printer 40 corresponding to each ink color as output values. In FIG. 4, an example of the original color conversion profile 15d is shown on the top and lists combinations of input values at the left column and output values at the right column. When an input RGB color component value is (R, G, B)=(8, 0, 0), for example, the corresponding output value is (C, M, Y, K, lc, lm)=(0, 5, 5, 249, 0, 0). That is, the original color conversion profile defines second correspondence between input and output values using multiple combinations. In FIG. 4, (RGB)₂ denotes color component values for specifying output colors on the printer in the RGB color coordinate system; and (CMYKlclm)₀ denotes CMYKlclm values for specifying the amount of ink used for the printer 40 corresponding to each ink color. The input values are selected similarly to the first color conversion profile 15b. Of course, the numeric values in FIG. 4 are provided as an example. The invention is not limited to these values or selection of the lattices.

As mentioned above, the color coordinate system for output values in the first color conversion profile 15b matches the color coordinate system for input values in the original color conversion profile 15d. After the color conversion based on the first color conversion profile 15b, further color conversion can be performed based on the original color conversion profile 15d. In this manner, the color conversion can be performed based on two color conversion profiles. As shown in FIGS. 3 and 4, the color coordinate system for output values in the first color conversion profile 15b matches the color coordinate system for input values in the original color conversion profile 15d. Even in this case, however, the output values differ from the input values.

To perform the color conversion as has been practiced so far, the interpolation needs to be performed for a result of the conversion using the first color conversion profile 15b with reference to the original color conversion profile 15d. Since this interpolation decreases the processing speed, the invention employs the construction that omits this interpolation. That is, a combination of output values in the first color conversion profile 15b matches a combination of input values in the second color conversion profile. Only reference to values can perform the color conversion based on the second color conversion profile.

The bottom of FIG. 4 shows an example of the second color conversion profile 15e. Also in this example, the left column shows combinations of input values. The right column shows combinations of output values. Similarly to the original color conversion profile 15d, the second color conversion profile 15e uses RGB color component values for specifying output colors on the printer 40 as input values and CMYKlclm values for specifying the amount of ink used for the printer 40 corresponding to each ink color as output values. That is, the second color conversion profile defines the second correspondence between input and output values using multiple combinations.

Even though the color coordinate system for the original color conversion profile 15d matches that for the second color conversion profile before and after the color conversion, both differ from each other in the combinations of input and output values. That is, the combination of input values in the second color conversion profile 15e is constructed to match the combination of output values in the first color conversion profile 15b. The combination of output values in the second color conversion profile 15e is the combination of corresponding CMYKlclm values when the output values in the first color conversion profile 15b are used as input values. The interpolation is used to calculate the combination of output values in the second color conversion profile 15e. (According to the embodiment, this process is referred to as construction to be described later in more detail.)

The embodiment previously creates the first color conversion profile 15b and the original color conversion profile 15d. The module creates the weight profile 15c and the second color conversion profile 15e for the print control as shown in FIG. 2. That is, after acquiring image data at Step S100, a weighting operation unit 21b1 of the color conversion module 21b creates the weight profile 15c (Step S102). As shown at the bottom of FIG. 3, the module calculates a weight for any color component value at each vertex. The calculated weight is assigned to each color component value and each vertex to create the weight profile 15c.

Further, an interpolation unit 21b2 of the color conversion module 21b performs the reconstruction based on the original color conversion profile 15d to create the second color conversion profile 15e (Step S105). That is, the original color conversion profile 15d defines the second correspondence between input and output values using multiple combinations. The interpolation unit performs the interpolation to make the correspondence between multiple input values in the original color conversion profile 15d and multiple output values in the first color conversion profile 15b, thus creating the second color conversion profile 15e. As a result, the created color conversion profile 15e contains the output values of the first color conversion profile 15b as input values.

Various techniques can be used for the interpolation. For example, it may be preferable to use the linear interpolation such as the tetrahedral interpolation or the nonlinear interpolation such as the spline interpolation. The former enables fast processing. The latter enables highly accurate interpolation. Using any of these interpolations, the interpolation unit 21b2 references the first color conversion profile 15b, uses a combination of output values as input values, and references the original color conversion profile 15d for interpolation.

To calculate the weight profile 15c, the interpolation unit 21b2 only needs to perform the interpolation as many times as the number of color component values (9³ according to the embodiment) contained in the cube formed by the vertexes a through h as shown in FIG. 3. To create the second color conversion profile, the interpolation unit 21b2 only needs to perform the interpolation as many times as the number of combinations (33³ according to the embodiment) of output values in the first color conversion profile 15b. These operations only need to be performed once in the print control process.

Performing operations to create these profiles do not greatly decrease speeds of the print control process and the color conversion process. Too many interpolations may be needed for a technique that individually performs weight calculations and interpolations as many times as pixels for image data (several megapixels for photo data). However, the invention does not individually calculate weights for respective pixels each time the color conversion is performed for each pixel in image data. The conversion based on the second color conversion profile eliminates the need for individual interpolation for each pixel. Accordingly, the invention can accelerate the processing speeds. According to the embodiment, the process at Step S102 is equivalent to the process in a weight profile acquisition unit U2. The process at Step S105 is equivalent to the process in a matching profile acquisition unit U1.

(2-2) Color Conversion

After creating the second color conversion profile 15e, the color conversion module 21b does the following to perform the color conversion. The color conversion module 21b references the first color conversion profile 15b and specifies an output value (referred to as a reference output value) to be referenced during the interpolation (Step S110). Multiple cubes are formed in the sRGB color space as shown at the middle of FIG. 3. Of these cubes, the color conversion module 21b specifies a cube that contains color component values for pixels of the image data acquired at Step S100. When an input value (reference input value) indicative of a cube vertex is specified, only reference to the value of the first color conversion profile 15b can specify the corresponding output value (referred to as the reference output value). In this manner, the color conversion module acquires multiple reference input values out of the multiple input values defined in the first color conversion profile 15b. Consequently, the reference input values can be referenced so as to interpolate output values corresponding to the color component values of the image data before the color conversion.

According to the embodiment, no interpolation is performed at this point. The color conversion module further references the second color conversion profile 15e. The color conversion module then specifies an output value (referred to as a final output value) corresponding to the reference output value out of the output values defined in the second color conversion profile (Step S115). Accordingly, the color conversion module extracts the same input value as the reference output value from the second color conversion profile 15e to acquire the corresponding final output value. The combination of input values in the second color conversion profile 15e matches the combination of output values in the first color conversion profile. At Step S115, the color conversion module can acquire the final output value only by referencing the correspondence defined in the second color conversion profile 15e. In this manner, the color conversion module acquires output values corresponding to the reference input values out of multiple output values defined in the second color conversion profile 15e.

After acquiring the final output value, the color conversion module acquires a weight to be multiplied by the final output value and multiplies the weight by the final output value to perform the color conversion (Step S120). That is, the color conversion module references the weight profile 15c to acquire the weight corresponding to the color component value of the image data acquired at Step S100. This weight corresponds to the vertex of the cube shown at the bottom of FIG. 3. The weight is predetermined for each vertex. Accordingly, the color conversion module acquires the weight corresponding to each reference input value in accordance with the weights defined in the weight profile 15c.

The final output value corresponds to the vertex of the cube shown at the bottom of FIG. 3.

The color conversion is performed by multiplying the weight and the final output value for each vertex as indicated by the following equation (2).

$${( CMYKlclm )}_{1 n} = {\sum }_{m = a}^{h} {( CMYKlclm )}_{1 m} \cdot \frac{{V}_{m}}{{V}_{0}} \qquad [ Equation 2 ]$$

In this equation, (CMYKlclm)ₗₙ indicates the result of converting color component values of the image data to be converted. (CMYKlclm)ₗₘ corresponds to the final output value. Reference symbol m corresponds to any of vertexes a through h. That is, reference numeral a indicates the final output value corresponding to the input value equivalent to vertex a as the reference input value. Vₘ/V₀ denotes a weight defined in the weight profile. Similarly, reference symbol m corresponds to reference symbols a through h.
Accordingly, the color conversion module multiplies each final output value by the weight corresponding to each reference input value to generate image data after the color conversion.

Equation (2) has the same form as equation (1). That is, implementing equation (1) is equivalent to performing the interpolation based on the first color conversion profile 15b. According to the invention, (RGB)ₗₘ in the right side of equation (1) matches the input value of the second color conversion profile 15e. (RGB)ₗₘ in the right side of equation (1) can be replaced by output value (CMYKlclm)ₗₘ of the second color conversion profile 15e. Since values are referenced at Steps S110 and S115 and equation (1) is changed to equation (2), it is possible to perform a single interpolation based on two profiles. According to the embodiment, the above-mentioned process at Steps S110 through S120 is equivalent to the process in a color conversion unit U3.

Performing the color conversion at Step S120 generates data that specifies CMYKlclm colors for the pixels of the image data acquired at Step S100. The halftoning module 21c performs a halftoning process (Step S125). That is, the halftoning module 21c converts a gradation value for each pixel represented by the CMYKlclm color coordinate system into halftone image data specifying whether or not to eject ink droplets. The halftoning module 21c determines whether or not to eject ink droplets corresponding to respective pixels for the printer 40. It may be preferable to not only determine whether or not to eject ink droplets, but also gradually control the amount of ejected ink droplets to determine sizes of ejected ink droplets.

The print data generation module 21d receives such halftone image data and sorts it in the order so as to be used on the printer 40 (Step S130). The print data generation module 21d individually outputs the halftone image data to the printer 40 in units of data used for one-time horizontal scanning (Step S135). The printer is mounted with an ink jet nozzle array as an inkjet device. The inkjet nozzle array is parallel provided with multiple inkjet nozzles in the vertical scanning direction. The printer 40 simultaneously uses data several dots apart from each other in the vertical scanning direction.

Data is orderly sorted so that the printer 40 simultaneously buffers data to be simultaneously used out of the data arranged in the horizontal scanning direction. The print data generation module 21d adds specified information such as image resolution to the sorted data to generate print data and outputs it to the printer 40 via the USB I/O interface 019b. After transfer of all the data needed to form an image on the printer 40, the printer 40 generates the image on a printout medium. According to the embodiment, the process at Steps S125 through S135 is equivalent to a print control unit that allows a printing device to print an image corresponding to the image data after the color conversion.

(3) Color Conversion Operations

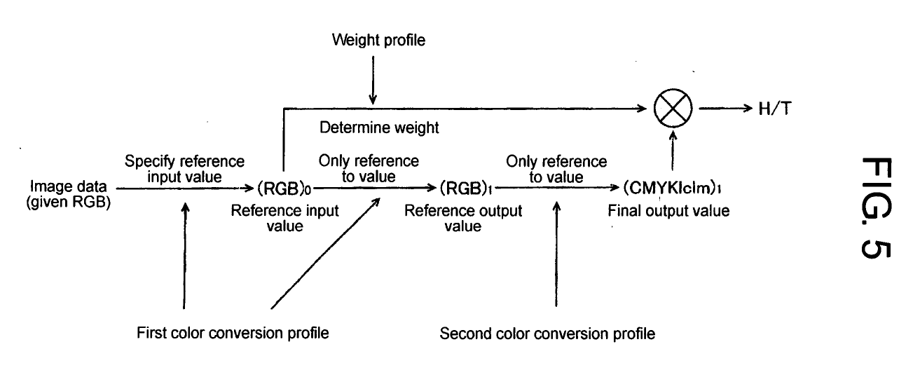

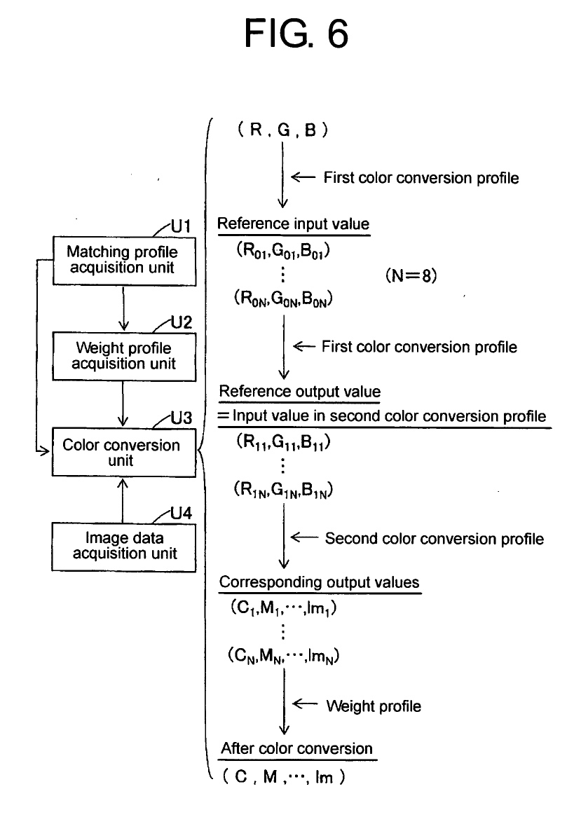

FIGS. 5 and 6 show color conversion operations in the above-mentioned print control process. FIG. 5 shows how image data to be printed passes through the first and second color conversions and is submitted to the halftoning process (H/T). As shown in FIG. 5, the image data is converted in terms of sRGB values (R, G, B) whose RGB color component value each can independently take 256 values. When an RGB value is specified, reference to the first color conversion profile 15b can specify N=8 vertexes positioned around the specified RGB value in the sRGB color space to easily determine the reference input values (R₀₁, G₀₁, B₀₁), . . . , and (R_{0N}, G_{0N}, B_{0N}).

When a reference input value is specified, only reference to the value defined in the first color conversion profile 15b can easily specify the reference output values (R₁₁, G₁₁, B₁₁), . . . , and (R_{1N}, G_{1N}, B_{1N}). The reference output value matches the input value of the second color conversion profile. Accordingly, only reference to the value defined in the second color conversion profile 15e can easily specify final output values (C₁, M₁, Y₁, K₁, lc₁, lm₁), . . . , and (C_{N}, M_{N}, Y_{N}, K_{N}, lc_{N}, lm_{N}). When the above-mentioned reference input value is specified, only reference to the value defined in the weight profile 15c can acquire the weight corresponding to each reference input value (also to the reference output value and the final output value) according to the relation between sRGB values and reference input values for the image data to be converted.

Based on the above-mentioned equation (2), the weight is multiplied by the final output value to acquire the color component value (C, M, Y, K, lc, lm) after the color conversion. In this manner, the color conversion is performed based on two profiles, i.e., the first color conversion 15b and the second color conversion 15e. Only the process of equation (2) is equivalent to the interpolation of pixels in the image data. The other processes simply reference values. Therefore, the color conversion based on two profiles can be performed with one stage of interpolation, not two stages of interpolation. It is possible to fast perform the process compared to that based on two stages of interpolation.

(4) Modification of the First Embodiment

According to the embodiment, an available construction is to perform the color conversion based on two profiles without performing the individual interpolation twice for each pixel. Another available construction is to be able to perform the color conversion without individually calculating weights during the interpolation. The other constructions can be employed. For example, the invention is not limited to the above-mentioned color coordinate systems that are converted using two profiles. The first color conversion profile may be used for color conversion from an RGB color coordinate system to a L*a*b* color coordinate system. The second color conversion profile may be used for color conversion from a L*a*b* color coordinate system to a CMYK color coordinate system. That is, the invention is not limited to any color coordinate system and can be applied to various color coordinate systems.

According to the above-mentioned embodiment, the second color conversion profile 15e is created from the original color conversion profile 15d. It may be preferable to previously create the second color conversion profile 15e, perform the reconstruction based on a specified original color conversion profile, and create the first color conversion profile 15b. Of course, the reconstruction may be performed for both profiles. During the reconstruction, it may be preferable to vary the number of combinations of input values and output values. The number of combinations need not be consistent before and after the reconstruction.

Further, according to the embodiment, the print control process creates the weight profile 15c based on the first color conversion profile 15b. The weight profile 15c only needs to be created at least before a weight is referenced. It may be preferable to previously create the weight profile 15c and acquire it during the print control process.

The invention can be applied to color conversions based on not only two profiles, but also more profiles. In this case, it is preferable that the combination of input values matches the combination of output values at least in the two profiles and that there is created a profile indicative of weights for the interpolation. Under this condition, the color conversion based on multiple profiles can terminate actually using only one interpolation. In addition, the color conversion can be performed without degrading the processing speed due to individually calculating weights. Fast processing is available.

While the embodiment calculates weights corresponding to the vertexes based on the cube's volume, the invention is not limited to this interpolation technique. For example, it may be preferable to use the tetrahedral interpolation or the interpolation based on a distance between a given point and the vertex. The above-mentioned embodiment uses the input values in the first color conversion profile 15b to generate cubes that are all equally sized. It may be preferable to define input values in the first color conversion profile 15b so as to generate differently sized cubes.

While the weight profile 15c assigns weights to three-dimensional input values, weights may be assigned to two-dimensional or one-dimensional input values. Depending on color coordinate systems, weights may be assigned to four-dimensional or higher input values. When a weight is assigned to a one-dimensional input value, for example, it is possible to acquire weights to interpolate any points on a line. The weight profile can be created by defining weights for lattice points on the line assuming that the interpolation is repeated for points on the line.

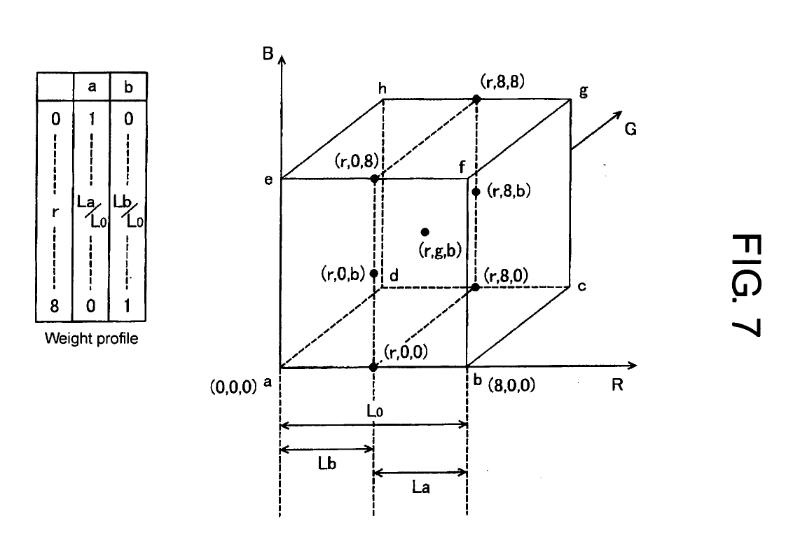

FIG. 7 diagramatically shows this example. An example of the one-dimensional weight profile is shown on the left of FIG. 7. This profile is used for an example of evenly arranging input values in the first color conversion profile 15b as shown in FIG. 3 to form cubic lattices. When the combination of input values forms equally sized cubic lattices, the weight profile only needs to define any color component value along one side of the cube (minimal cube as mentioned above) as shown in FIG. 7.

The weight profile on the left of FIG. 7 defines weights of input values 0 through 8 for each of lattice points a and b. On the left of FIG. 7, let us assume L₀ to be the length of a line connecting lattice points a and b, (r, 0, 0) to be a given point, Lₐ to be the distance from lattice point a to the given point, and L_{b} to be the distance from lattice point b to the given point. The linear interpolation calculates an output value corresponding to this point using weight Lₐ/L₀ for lattice point a and weight L_{b}/L₀ for lattice point b.

Reference to this weight profile can calculate point (r, 0, 8) on the line parallel to line ab based on lattice points e and f, calculate point (r, 8, 8) based on lattice points h and g, and calculate point (r, 8, 0) based on lattice points d and c. The example in FIG. 7 uses the same distance between the lattice points. Therefore, the weight profile can be used for directions B and G. When the weight profile is used to acquire weights for interpolation in the B direction, point (r, 0, b) can be calculated based on points (r, 0, 8) and (r, 0, 0). Point (r, 8, b) can be calculated based on points (r, 8, 8) and (r, 8, 0).

Further, when the weight profile is used to acquire weights for the interpolation in the G direction, point (r, g, b) can be calculated based on points (r, 0, b) and (r, 8, b). When a series of interpolations is streamlined using equations, an interpolation equation can be expressed using only output values associated with the original lattice points a through h and the weights. The color conversion is performed so as to acquire a weight for a given color component value, assign the weight to the interpolation equation, and assign the final output value acquired from the second color conversion profile 15e to the interpolation equation. In this manner, it is possible to perform the color conversion based on two profiles actually using the interpolation once.

This is also an example. It may be preferable to create a two-dimensional weight profile. Various interpolation sequences and techniques can be used. A one-dimensional weight profile may be defined in each of RGB directions. In this case, the one-dimensional weight profile can be used when the color conversion profile 15b contains input values whose intervals differ from each other in all the RGB directions. When input value intervals differ from each other in the same direction, it is a good practice to provide multiple weight profiles in advance. According to this construction, weights can be easily defined even when unequal intervals are used for the input value defined in the first color conversion profile 15b. The invention can be applied to various profiles.

(5) Construction of the Print Control Device According to a Second Embodiment

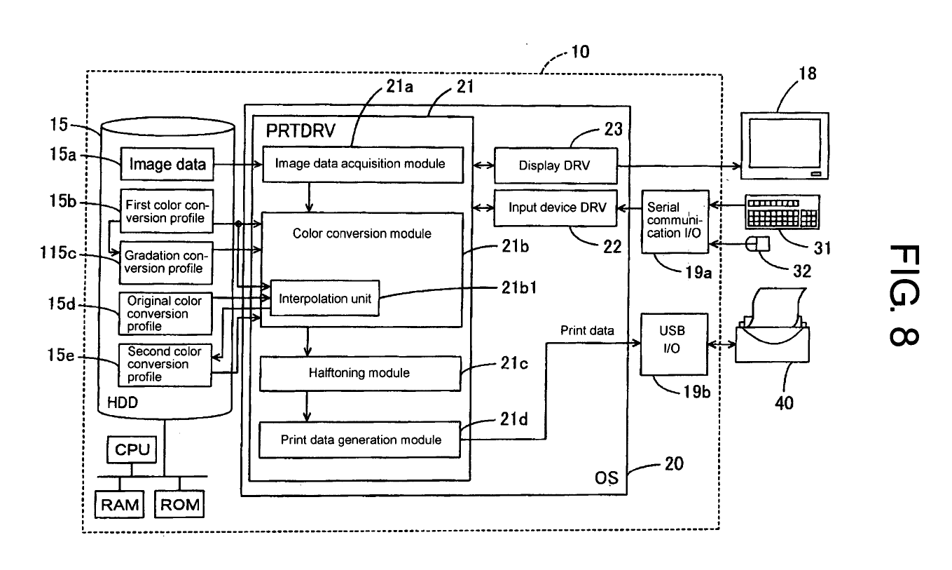

FIG. 8 is a block diagram outlining the construction of a computer functioning as the print control device and the color conversion device according to the second embodiment. In this construction, the HDD 15 stores a gradation conversion profile 115c instead of the weight profile 115c. The color conversion module 21b is not provided with the weighting operation unit 21b1. The remaining part of the construction is the same as the first embodiment.

(2) Print Control Process

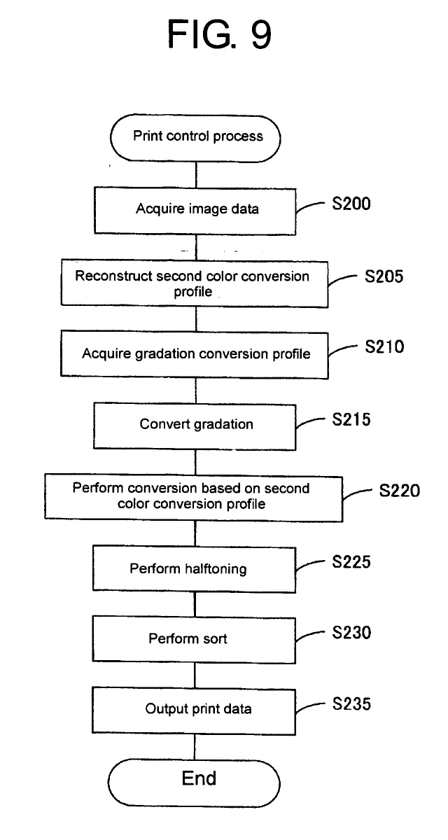

FIG. 9 is a flowchart showing the print control process. When a print instruction is issued, the image data acquisition module 21a acquires the image data 15a indicative of the image for which the print instruction is issued from the application program. According to the embodiment, the process at Step S200 is equivalent to the process in an image data acquisition unit U6.

The color conversion module 21b converts the color coordinate system representing colors of pixels (Steps S205 through S220). That is, the color conversion module 21b performs the color conversion using the first color conversion profile 15b, the gradation conversion profile 115c, and the original color conversion profile 15d that are prepared in advance. At this time, the color conversion module 21b performs a process to generate the second color conversion profile 15e from the original color conversion profile 15d. The color conversion module 21b performs the two-stage color conversion using the second color conversion profile 15e and the above-mentioned profiles.

(6-1) Details of the Profiles

According to the embodiment, the first color conversion profile 15b uses sRGB color component values as input values and RGB color component values as output values for specifying output colors on the printer 40. That is, the first color conversion profile defines first correspondence between input and output values using multiple combinations. The original color conversion profile 15d uses RGB color component values for specifying output colors on the printer as input values and CMYKlclm values for specifying the amount of ink used for the printer 40 corresponding to each ink color as output values. That is, the original color conversion profile defines second correspondence between input and output values using multiple combinations.

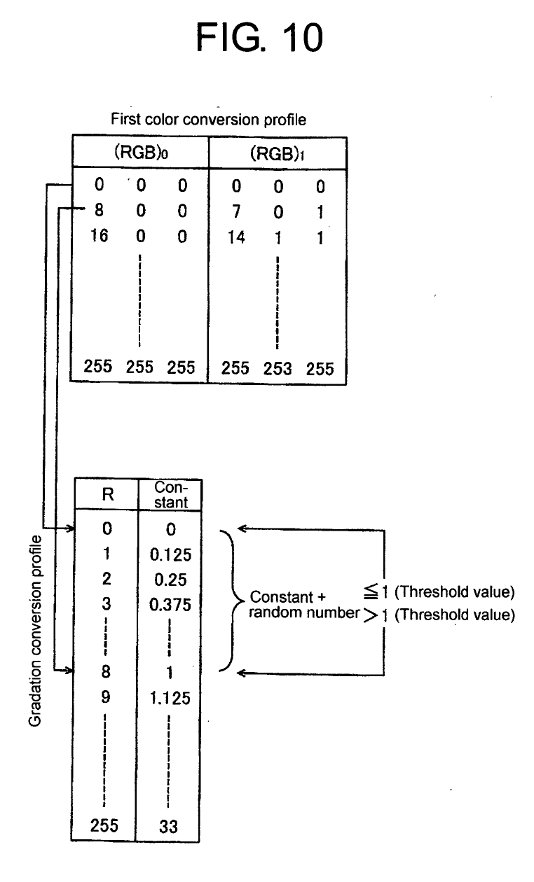

FIGS. 10 and 4 diagramatically show these profiles. In FIG. 10, an example of the first color conversion profile 15b is shown on the top and lists combinations of input values at the left column and output values at the right column. When an input sRGB color component value is (R, G, B)=(8, 0, 0), for example, the corresponding output value is (R, G, B)=(7, 0, 1).

In FIG. 10, (RGB)₀ denotes color component values in the sRGB color coordinate system; and (RGB)₁ denotes color component values in RGB color coordinate system for specifying output colors on the printer 40. The input values provide combinations of values (33 values for each color) resulting from dividing a gradation range of sRGB color component values into 32 for each color. Let us consider an orthogonal space using the sRGB colors as axes. Input values are selected so that lattice points corresponding to the input values form a cubic lattice. Of course, the numeric values in FIG. 3 are provided as an example. The invention is not limited to these values or selection of the lattices.

In FIG. 4, an example of the original color conversion profile 15d is shown on the top and lists combinations of input values at the left column and output values at the right column. When an input RGB color component value is (R, G, B)=(8, 0, 0), for example, the corresponding output value is (C, M, Y, K, lc, lm)=(0, 5, 5, 249, 0, 0). In FIG. 4, (RGB)₂ denotes color component values for specifying output colors on the printer in the RGB color coordinate system; and (CMYKlclm)₀ denotes CMYKlclm values for specifying the amount of ink used for the printer 40 corresponding to each ink color. The input values are selected similarly to the first color conversion profile 15b. Of course, the numeric values in FIG. 4 are provided as an example. The invention is not limited to these values or selection of the lattices.

As mentioned above, the color coordinate system for output values in the first color conversion profile 15b matches the color coordinate system for input values in the original color conversion profile 15d. After the color conversion based on the first color conversion profile 15b, further color conversion can be performed based on the original color conversion profile 15d. In this manner, the color conversion can be performed based on two color conversion profiles. As shown in FIGS. 10 and 4, the color coordinate system for output values in the first color conversion profile 15b matches the color coordinate system for input values in the original color conversion profile 15d. Even in this case, however, the output values differ from the input values.

To perform the color conversion as has been practiced so far, the interpolation needs to be performed for a result of the conversion using the first color conversion profile 15b with reference to the original color conversion profile 15d. Since this interpolation decreases the processing speed, the invention employs the construction that omits this interpolation. That is, the invention is constructed to perform the color conversion using the gradation conversion profile 115c created based on the first color conversion profile 15b and the second color conversion profile created based on the original color conversion profile 15d.

FIG. 10 shows an example of the gradation conversion profile 115c at the bottom. The gradation conversion profile 115c maintains correspondence between sRGB color component values and predetermined constants. The gradation conversion profile 115c decreases the number of gradations (256 according to the embodiment) for each color of sRGB color components. The gradation conversion profile 115c provides the decreased number of gradations (33 according to the embodiment as mentioned above) for each color as input values for the first color conversion profile 15b.

The input value defined in the first color conversion profile 15b is predetermined for each color component (e.g., 0,8,16, , , , ). The embodiment converts a given color component value of image data into any of the predetermined values. The gradation conversion profile 115c assigns each color component value a constant that indicates the degree of ease of conversion into any of the predetermined values. The conversion is performed based on this constant.

The constant is determined to be standardized so that an interval between the predetermined values is set to 1. For example, let us suppose that the first color conversion profile 15b contains the color components whose input values vary in the order of 0, 8, and 16. In this case, constant 0 corresponds to input value 0 and constant 1 corresponds to input value 8. At this time, constant ⅛ (0.125) corresponds to input value 1. Constant 9/8 (1.125) corresponds to input value 9. The conversion process using the gradation conversion profile 115c will be described later in detail.

According to the embodiment, the first color conversion profile 15b defines the input values common to the respective colors. When the gradation conversion profile 115c is created for a given color, the gradation conversion profile 115c can be used for all the colors. According to the invention, the gradation conversion profile 115c is created before the print control process in FIG. 9 is performed.

FIG. 4 shows an example of the second color conversion profile 15e at the bottom. The second color conversion profile 15e uses RGB color component values for specifying output colors on the printer 40 as input values and CMYKlclm values for specifying the amount of ink used for the printer 40 corresponding to each ink color as output values. That is, the second color conversion profile defines the second correspondence between input and output values using multiple combinations.

That is, the combination of input values in the second color conversion profile 15e is constructed to match the combination of output values in the first color conversion profile 15b. The combination of output values in the second color conversion profile 15e is the combination of corresponding CMYKlclm values when the output values in the first color conversion profile 15b are used as input values. The interpolation is used to calculate the combination of output values in the second color conversion profile 15e.

The embodiment previously creates the first color conversion profile 15b, the gradation conversion profile 115c, and the original color conversion profile 15d. The module creates the second color conversion profile 15e for the print control as shown in FIG. 9. That is, after the image data is acquired at Step S200, the reconstruction is performed to create the second color conversion profile 15e (Step S205). For this purpose, the color conversion module 21b has an interpolation unit 21b1. The interpolation unit 21b1 performs interpolation by referencing the original color conversion profile 15d. As mentioned above, the original color conversion profile 15d predefines the second correspondence using multiple combinations. The interpolation unit performs the interpolation to make a correspondence between multiple input values in the original color conversion profile 15d and multiple output values in the first color conversion profile 15b to create the second color conversion profile 15e. As a result, the created second color conversion profile 15e uses the output values for the first color conversion profile 15b as input values.

The above-mentioned various techniques can be employed for this interpolation. The interpolation only needs to be performed as many times as the number of combinations (33³ according to the embodiment) of output values in the first color conversion profile 15b. In addition, the interpolation only needs to be performed once in the print control process. Performing the interpolation does not greatly decrease speeds of the print control process and the color conversion process. Too many interpolations may be needed for a technique that interpolates as many times as pixels for image data (several megapixels for photo data). However, the invention does not perform interpolation for respective pixels each time the color conversion is performed for each pixel in image data. According to the embodiment, the process at Step S205 is equivalent to the process in a matching profile acquisition unit U5.

(6-2) First Color Conversion

After creating the second color conversion profile 15e, the color conversion module 21b acquires the gradation conversion profile 115c to perform the first stage of the color conversion (Step S210). In accordance with a given gradation conversion rule defined in the gradation conversion profile, the color conversion module 21b performs the gradation conversion to convert each color component value in the image data into any of input values in the first color conversion profile 15b (Step S215). The color conversion module 21b performs the gradation conversion by comparing the sum of an output value (a constant as shown in FIG. 10 at the bottom) defined in the gradation conversion profile 115c and a random number with a specified threshold value.

According to the embodiment, a random number between 0 and 1 is generated for each pixel in the image data. The threshold value is predetermined in accordance with the input values (0,8,16, , , , as the example in FIG. 10) defined in the first color conversion profile 15b. According to the embodiment, the threshold value is common to any given color component values sandwiched between the input values. The threshold value is an integer resulting from rounding up the fractional part of the constant defined in the gradation conversion profile 115c. For example, constants 0.125 through 1 are assigned to input values 1 through 8 in the gradation conversion profile 115c. Threshold value 1 is used for color component values 1 through 8.

As shown at the bottom of FIG. 10, the constant defined in the gradation conversion profile 115c equals the threshold value by rounding up the fractional part of the constant. Therefore, the “sum of the constant defined in the gradation conversion profile 115c and a random number” ranges from “threshold value−1” to “threshold value+1.” At Step S215, the color conversion module 21b references the gradation conversion profile 115c to acquire the constant corresponding to each color component value for each pixel in the image data. A random number is generated for each color component value.

The color conversion module 21b then finds the sum of the constant and the random number and compares the sum with the threshold value. As a result, when the sum is determined to be smaller than or equal to the threshold value, the color conversion module 21b selects a smaller one of input values that are defined in the first color conversion profile 15b and sandwich the color component value to be converted. When the sum is determined to be greater than the threshold value, the color conversion module 21b selects a larger one of input values that are defined in the first color conversion profile 15b and sandwich the color component value to be converted.

For example, color component value 3 corresponds to threshold value 1. The gradation conversion profile 115c assigns constant 0.375 to color component value 3. At this time, two input values 0 and 8 belong to the input values defined in the first color conversion profile 15b and sandwich color component value 3 to be converted. When the random number is 0.5, the sum of constant and random number is 0.875 that is smaller than threshold value 1, the conversion of color component value 3 results in 0. When the random number is 1, the sum of constant and random number is 1.5 that is greater than threshold value 1, the conversion of color component value 3 results in 8.

According to the embodiment, the color conversion module 21b converts the color component value for each pixel of the image data into a value equal to the input value defined in the first color conversion profile 15b based on the gradation conversion profile 115c. The color conversion module 21b then references the first color conversion profile 15b to acquire the output value associated with the input value and uses the output value as an RGB value for each pixel. That is, the color conversion module acquires the output value corresponding to the input value after the conversion out of multiple output values defined in the first color conversion profile. The color conversion module references the gradation conversion profile 115c to convert a given color component value for each pixel of the image data into any of color-based input values defined in the first color conversion profile 15b. A combination of values after the conversion matches any of combinations of input values defined in the first color conversion profile 15b.

Acquiring an output value associated with this combination is equivalent to converting any combination of color component values into any combination of output values in the first color conversion profile 15b. In this manner, the color conversion is performed from the sRGB color coordinate system into the RGB color coordinate system used for the printer 40 without interpolating any image data. In this example, any color component value (256 gradations) is converted into any of predetermined input values (33 in total). The use of the above-mentioned constants increases the possibility of converting each color component value into an input value approximate to the color component value. Further, the use of random numbers prevents values from being uniformly converted into a predetermined input value. Accordingly, the conversion is available without greatly damaging the gradation property. According to the embodiment, the process at Steps S210 and S215 is equivalent to the process of a first color conversion unit U7.

(6-3) Second Color Conversion

After performing the first color conversion to decrease the number of gradations at Step S215, the color conversion module 21b performs color conversion by referencing the second color conversion profile 15e (Step S220). The combination of input values in the second color conversion profile 15e matches that of output values in the first color conversion profile 15b. All values acquired at Step S215 above match the combination of output values in the first color conversion profile 15b. That is, the color conversion module acquires an output value from the first color conversion profile and uses the output value as an input value for the second color conversion profile. The color conversion module acquires an output value out of multiple output values that are defined in the second color conversion profile and correspond to that input value. In this manner, the color conversion module generates image data after the color conversion.

During the color conversion at Step S220, the input values match the combination of input values in the second color conversion profile 15e. Accordingly, the color conversion can be performed without performing the interpolation only by referencing the second color conversion profile 15e and acquiring a combination of output values corresponding to the combination of input values. As a result, the color conversion can be performed very fast. According to the embodiment, the process at Step S220 is equivalent to the process in a second color conversion unit U8.

As mentioned above, performing the second color conversion generates data that specifies CMYKlclm colors for pixels in the image data acquired at Step S200. The halftoning module 21c performs a halftoning process (Step S225). The print data generation module 21d receives such halftone image data and sorts it in the order so as to be used on the printer 40 (Step S230). The print data generation module 21d individually outputs the halftone image data to the printer 40 in units of data used for one-time horizontal scanning (Step S235). The print data generation module 21d adds specified information such as image resolution to the sorted data to generate print data and outputs it to the printer 40 via the USB I/O interface 019b. After transfer of all the data needed to form an image on the printer 40, the printer 40 generates the image on a printout medium. According to the embodiment, the process at Steps S225 through S235 is equivalent to the print control unit that allows a printing device to print an image corresponding to the image data after the color conversion.

(7) Color Conversion Operations

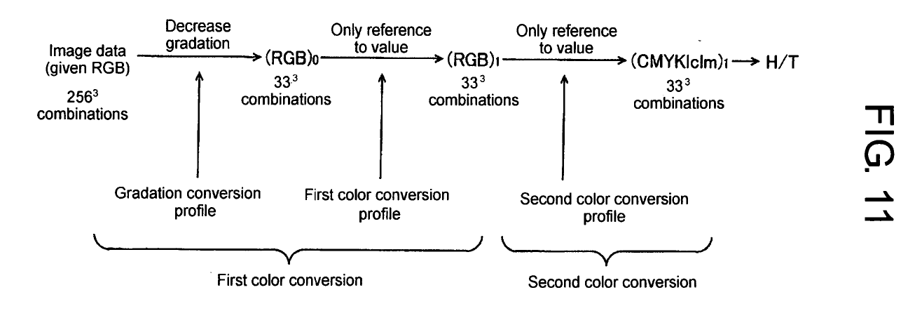

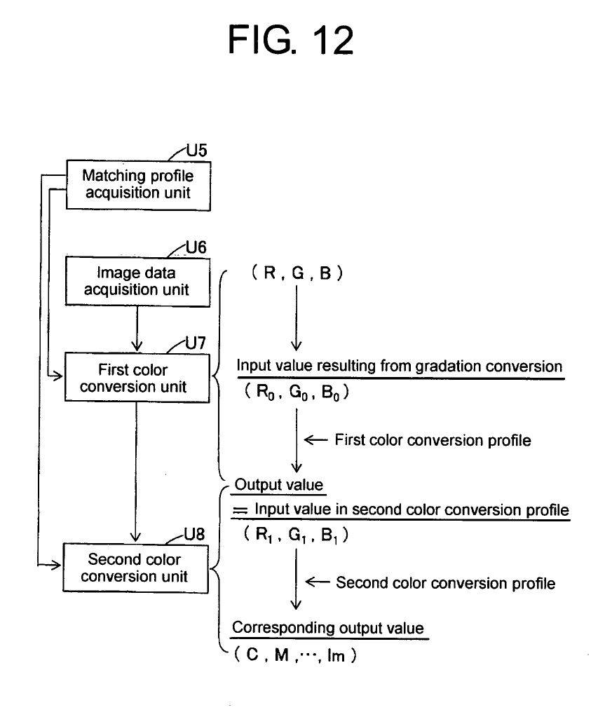

FIGS. 11 and 12 show color conversion operations in the above-mentioned print control process. FIG. 11 shows how image data to be printed passes through the first and second color conversions and is submitted to the halftoning process. FIG. 11 also shows the number of values available for the image data and a profile to be referenced at each stage. The image data acquired at Step S200 has RGB color component values (R, G, B) each of which can be independently assigned 256 values. Accordingly, there are 256³ combinations of values available for each pixel in the image data.

A normal interpolation uses any of 256³ values as input, references the profile for interpolation, and outputs any of 256³ values. Generally, this operation is heavily loaded, causing the processing speed to decrease. According to the above-mentioned embodiment, the module references the gradation conversion profile 115c and converts a given color component value into only any of input values in the first color conversion profile 15b. The conversion can be faster than the interpolation. That is, the module can complete the conversion of color component values (R, G, B) for pixels simply by calculating the sum of a predetermined constant and a random number and comparing the sum with the threshold value. The fast processing is available.

According to the embodiment as shown in FIG. 10, the 256-gradation color component value for each color is converted into any of 33 gradation values. Available combinations after the conversion are 33³. The 33³ value combinations match the combinations of input values (expressed as ((RGB)₀) in the first color conversion profile 15b. Simply reference to the values defined in the first color conversion profile 15b can convert a conversion result using the gradation conversion profile 115c into a combination (expressed as ((RGB)₁) of output values defined in the first color conversion profile 15b. The above-mentioned conversion (first color conversion) is based on and references the first color conversion profile. The conversion can acquire a combination of output values without performing interpolation. Accordingly, the conversion can be very fast.

After the first color conversion terminates, the second color conversion profile 15e is used for the next conversion. At this time, the combination ((RGB)₁) of output values defined in the first color conversion profile 15b matches the combination of input values defined in the second color conversion profile 15e. Simply referencing the output values defined in the second color conversion profile 15e enables the conversion. It is possible to acquire color component values (C, M, Y, K, lc, lm) after the color conversion. Since this conversion also uses 33³ combinations of input values, there are 33³ combinations of output values.

When the second color conversion profile 15e is created, the embodiment performs the interpolation by referencing the original color conversion profile 15d. As mentioned above, the interpolation is performed for at most 33³ values. The fast processing is available in comparison with the ordinary color conversion using the interpolation for several megapixels. The interpolation according to the embodiment only needs to be performed at least once before the color conversion. The speed is remarkably improved when the color conversion is performed for multiple images.

The second color conversion according to the embodiment signifies the color conversion using the second color conversion profile 15e. Accordingly, the embodiment performs two stages of color conversion, i.e., the first color conversion based on the first color conversion profile 15b and the second color conversion based on the second color conversion profile 15e (or based on the original color conversion profile 15d). When the interpolation is performed as has been practiced so far, the two-stage interpolation needs to be performed for may pixels. According to the embodiment, however, a small quantity of interpolation is performed at an early stage of the color conversion. The color conversion can be performed with no interpolation, subsequently. The fast processing is available.

The invention omits the interpolation using a match between the combination of output values in the first color conversion profile 15b and the combination of input values in the second color conversion profile 15e. According to the embodiment, however, there is no match between the combinations of output values and input values in the prepared profiles (the first color conversion profile 15b and the original color conversion profile 15d). Even in such case, both can match by performing the reconstruction based on the above-mentioned interpolation.

Accordingly, there is no specific limitation on the number of combinations of input values and output values defined in the first color conversion profile 15b and the second color conversion profile 15e. The color conversion can be performed by making a match between the combinations of input values and output values. As a result, the fast color conversion can be performed based on not only predetermined profiles, but also any multiple profiles.

(8) Other Embodiments

The above-mentioned embodiments only need to be capable of performing the pixel-based individual color conversion without performing interpolation. The other constructions may be employed. For example, the invention is not limited to the above-mentioned color coordinate system to be converted by using two profiles.

It may be preferable to create the second color conversion profile 15e in advance, perform the reconstruction based on a specified original color conversion profile, and create the first color conversion profile 15b. Of course, the reconstruction may be performed for both. The reconstruction may not increase or decrease the number of combinations of input values and the number of combinations of output values. The number of combinations is not required to be constant before and after the reconstruction.

According to the above-mentioned embodiments, the gradation conversion profile 115c is created in advance. The gradation conversion profile 115c may be created based on the first color conversion profile 15b before the color conversion. This process eliminates the need for creating the gradation conversion profile 115c in advance, thus improving the general versatility. Of course, the invention is not limited to the above-mentioned techniques to determine constants to be associated with the color component values.

For example, integer constants are assigned to predetermined values as input values in the first color conversion profile 15b. When the constants therebetween are associated with constants containing fractional parts, the constant need not linearly vary with the color component value and may vary nonlinearly. Various construction scan be employed such as defining constants using at one curve. This construction can control the degree of ease of converting color component values using the gradation conversion profile 115c. It is not mandatory to uniformly select input values for the first color conversion profile 15b from the entire range of values. Input values may be selected at uneven intervals.

The invention is not limited to the construction where the gradation conversion profile 115c is referenced for converting a given color component value in the image data into a given input value defined in the first color conversion profile 15b. According to a possible construction, for example, the halftoning process is applied to image data so that the halftoning process results in only input values defined in the first color conversion profile 15b. As such construction, various constructions can be employed. Various techniques can be employed such as the error diffusion for multiple values, the minimized average error method, and the ordered dither method for multiple values.

Further, the invention may be applied to color conversion based on much more profiles. When the combination of input values matches the combination of output values in at least two profiles, the color conversion can proceed for these profiles by omitting the interpolation. The fast processing is available.

While the invention has been particularly shown and described with respect to preferred embodiments thereof, it should be understood by those skilled in the art that the foregoing and other changes in form and detail may be made therein without departing from the sprit and scope of the invention as defined in the appended claims.

What is claimed is:

1. A color conversion method for applying color conversion to image data whose pixel color is specified by a color component value, the method comprising:
acquiring a first color conversion profile and a second color conversion profile, wherein the first and second color conversion profiles define correspondence between input and output values using multiple combinations and a plurality of output values in the first color conversion profile matches a plurality of input values in the second color conversion profile;
acquiring a weight profile indicative of weights for interpolating an output value corresponding to a given input value by using a weighting operation based on a plurality of output values in the first color conversion profile;
acquiring a plurality of reference input values referenced to interpolate an output value corresponding to a color component value of the image data based on the first color conversion profile;
acquiring a weight for each of the reference input values based on the weight profile;
acquiring an output value corresponding to each of the reference input values based on the second color conversion profile; and
generating image data after color conversion by multiplying each of the output values by the acquired weight.

2. The color conversion method according to claim 1, comprising: performing interpolation based on a precreated original color conversion profile to create at least one of the first color conversion profile and the second color conversion profile; and making a correspondence between a plurality of output values in the first color conversion profile and a plurality of input values in the second color conversion profile by performing the interpolation.

3. The color conversion method according to claim 1, wherein the weight profile defines weights to be multiplied by output values corresponding to the plurality of input values with respect to color component values within a specified unit region to be formed in a color space by a plurality of input values in the first color conversion profile.

4. The color conversion method according to claim 3, comprising:
calculating weights for color component values within the specified unit region and acquiring the weight profile for making a correspondence between color component values and weights by referencing the first color conversion profile.

5. The color conversion method according to claim 1,
wherein the first color conversion profile defines first correspondence between input values and output values using multiple combinations;
wherein the second color conversion profile defines second correspondence between input values and output values using multiple combinations; and
wherein the method comprises:
making a correspondence between multiple input values in an original color conversion profile for predefining the second correspondence using multiple combinations and multiple output values in the first color conversion profile to create the second color conversion profile by performing the interpolation;
acquiring multiple reference input values out of multiple input values defined in the first color conversion profile so that the multiple reference input values can be referenced during interpolation of output values corresponding to color component values of the image data;
acquiring a weight corresponding to each of the reference input values according to a weight defined in the weight profile;
acquiring each output value corresponding to each of the reference input values out of a plurality of output values defined in the second color conversion profile; and
acquiring each of the output values by a weight corresponding to each of the reference input values to generate image data after color conversion.

6. A color conversion method for applying color conversion to image data whose pixel color is specified by a color component value, the method comprising:
acquiring a first color conversion profile and a second color conversion profile, wherein the first and second color conversion profiles define correspondence between input and output values using multiple combinations and a plurality of output values in the first color conversion profile matches a plurality of input values in the second color conversion profile;
converting a color component value of the image data into an output value in the first color conversion profile based on the first color conversion profile; and
generating image data after color conversion by using an output value in the acquired first color conversion profile as an input value in the second color conversion profile and converting the input value into an output value based on the second color conversion profile.

7. The color conversion method according to claim 6 comprising:
creating at least one of the first color conversion profile and the second color conversion profile by means of interpolation based on a precreated original color conversion profile; and
making a correspondence between a plurality of output values in the first color conversion profile and a plurality of input values in the second color conversion profile by performing the interpolation.

8. The color conversion method according to claim 6 comprising:
converting a color component value of the image data before color conversion into any of input values in the first color conversion profile according to a specified gradation conversion rule;
converting a converted input value into an output value in the first color conversion profile; and
generating image data after color conversion by converting a resulting output value as an input value in the second color conversion profile into an output value in the second color conversion profile.

9. The color conversion method according to claim 6,
wherein the first color conversion profile defines first correspondence between input values and output values using multiple combinations;
wherein the second color conversion profile defines second correspondence between input values and output values using multiple combinations; and
wherein the method comprises:
creating the second color conversion profile by performing the interpolation to make a correspondence between multiple input values in an original color conversion profile for predefining the second correspondence using multiple combinations and multiple output values in the first color conversion profile;
converting a color component value of the image data into any of input values in the first color conversion profile according to a specified gradation conversion rule;
acquiring an output value corresponding to the converted input value out of a plurality of output values defined in the first color conversion profile; and
generating image data after color conversion by using an acquired output value as an input value in the second color conversion profile and acquiring an output value corresponding to the input value out of a plurality of output values defined in the second color conversion profile.

10. A print control method of providing control for allowing a printing device to print an image corresponding to image data whose pixel color is specified by a color component value, the method comprising:
acquiring a first color conversion profile and a second color conversion profile, wherein the first and second color conversion profiles define correspondence between input and output values using multiple combinations and a plurality of output values in the first color conversion profile matches a plurality of input values in the second color conversion profile;
acquiring a weight profile indicative of weights for interpolating an output value corresponding to a given input value by using a weighting operation based on a plurality of output values in the first color conversion profile;
acquiring a plurality of reference input values referenced to interpolate an output value corresponding to a color component value of the image data based on the first color conversion profile;
acquiring a weight for each of the reference input values based on the weight profile;
acquiring an output value corresponding to each of the reference input values based on the second color conversion profile; and
generating image data after color conversion by multiplying each of the output values by the acquired weight; and
allowing a printing device to print a corresponding image based on image data after the color conversion.

11. A color conversion device for applying color conversion to image data whose pixel color is specified by a color component value, the device comprising:
a matching profile acquisition unit that acquires a first color conversion profile and a second color conversion profile, wherein the first and second color conversion profiles define correspondence between input and output values using multiple combinations and a plurality of output values in the first color conversion profile matches a plurality of input values in the second color conversion profile;
a weight profile acquisition unit that acquire a weight profile indicative of weights for interpolating an output value corresponding to a given input value by using a weighting operation based on a plurality of output values in the first color conversion profile; and
a color conversion unit that acquires a plurality of reference input values referenced to interpolate an output value corresponding to a color component value of the image data based on the first color conversion profile, acquires a weight for each of the reference input values based on the weight profile, acquires an output value corresponding to each of the reference input values based on the second color conversion profile, and performs color conversion by multiplying each of the output values by the acquired weight.

12. A medium for recording a color conversion program that allows a computer to implement a function to apply color conversion to image data whose pixel color is specified by a color component value, the function comprising:
a matching profile acquisition function that acquires a first color conversion profile and a second color conversion profile, wherein the first and second color conversion profiles define correspondence between input and output values using multiple combinations and a plurality of output values in the first color conversion profile matches a plurality of input values in the second color conversion profile;
a weight profile acquisition function that acquire a weight profile indicative of weights for interpolating an output value corresponding to a given input value by using a weighting operation based on a plurality of output values in the first color conversion profile; and
a color conversion function that acquires a plurality of reference input values referenced to interpolate an output value corresponding to a color component value of the image data based on the first color conversion profile, acquires a weight for each of the reference input values based on the weight profile, acquires an output value corresponding to each of the reference input values based on the second color conversion profile, and performs color conversion by multiplying each of the output values by the acquired weight.
